(19) United States
(12) Patent Application Publication
(10) Pub. No.: US 2026/0295486 A1
(43) Pub. Date: Oct. 1, 2026

(54) FOLDING COVER FOR AIR FILTER UNIT

(71) Applicant: CTT TRADING ASIA LIMITED, HONG KONG (CN)

(72) Inventors: Xingyi LI, Heshan (CN); Yongsheng LI, Heshan (CN); Yongkang LI, Heshan (CN); Xingsi LI, Heshan (CN)

(21) Appl. No.: 19/213,987

(22) Filed: May 20, 2025

(30) Foreign Application Priority Data
Mar. 28, 2025 (CN) 202520578538.4

(51) Int. Cl. B01D 46/00

(52) U.S. Cl. CPC B01D 46/0004; B01D 46/0005; B01D 2265/06

(57) ABSTRACT

A folding cover for an air filter unit including two frame assemblies. The two frame assemblies are symmetrical about a central point and includes two first frames and two second frames. The two first frames are connected to the two second frames, respectively. Each of the two first frames includes a first end, a second end, a first top surface, and a first bottom surface. A semicircular plate is fixedly disposed on the first end of each first frame. Each of the two second frames includes a third end, a fourth end, a second top surface, and a second bottom surface. The second top surface of each second frame includes a semicircular groove. The semicircular groove is disposed on the third end. The semicircular plate is rotatably disposed within the semicircular groove. The second end of the first frame is pivotally connected to the fourth end.

### CROSS-REFERENCE TO RELATED APPLICATIONS

Pursuant to 35 U.S.C. § 119 and the Paris Convention Treaty, this application claims foreign priority to Chinese Patent Application No. 202520578538.4 filed Mar. 28, 2025, the contents of which, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, MA 02142.

### BACKGROUND

The disclosure relates to the field of air filters, and more particularly, to a folding cover for an air filter unit.

Air filter units are increasingly utilized across modern industrial, residential, and commercial sectors. Their primary function is to remove harmful substances such as particulate matter, pollutants, bacteria, and viruses from the air through filter media, thereby providing purified air. Conventional air filter units typically incorporate a filter element to clean the airflow generated by fans, eliminating airborne particles and impurities.

However, conventional filters for air filtration devices face a critical drawback: to maintain unrestricted airflow while achieving required purification efficiency, these filters necessitate larger volumes and dimensions. Consequently, their matching cover plates must also increase in size. Since these cover plates cannot be folded, they occupy excessive space during storage or transportation, significantly escalating logistical challenges and operational costs.

### SUMMARY

To solve the aforesaid problems, the disclosure provides a folding cover for an air filter unit. The folding cover comprises two frame assemblies. The two frame assemblies are symmetrical about a central point; each of the two frame assemblies comprises two first frames and two second frames. The two first frames are disposed opposite to each other, and the two second frames are disposed opposite to each other. The two first frames are connected to the two second frames, respectively. Each of the two first frames comprises a first end, a second end, a first top surface, and a first bottom surface. A semicircular plate is fixedly disposed on the first end of each first frame. Each of the two second frames comprises a third end, a fourth end, a second top surface, and a second bottom surface. The second top surface of each second frame comprises a semicircular groove; the semicircular groove is disposed on the third end of the second frame; the semicircular plate is rotatably disposed within the semicircular groove; and the second end of the first frame is pivotally connected to the fourth end of the second frame.

In a class of this embodiment, the second bottom surface of each second frame comprises two latch blocks. Each latch block comprises a side wall defining a latch interface. Each semicircular plate comprises a third top surface and a third bottom surface. Both the third bottom surface of each semicircular plate and the first bottom surface of each of the two first frames comprise a rotary shaft; the rotary shaft is detachably disposed in the latch block through the latch interface; and one end of the rotary shaft is fixed with a stop block.

In a class of this embodiment, the first bottom surface of each first frame comprises a stop plate.

In a class of this embodiment, the third top surface of each semicircular plate comprises a directional indicator.

In a class of this embodiment, both the first top surface of each of the two first frames and the second top surface of each of the two second frames comprise a lightweight groove.

In a class of this embodiment, both the first top surface of each of the two first frames and the second top surface of each of the two second frames comprise a positioning hole.

The following advantages are associated with the folding cover of the disclosure.

When the folding cover is to be stored or transported, the two second frames are urged inward toward one another, thereby causing the two semicircular plates to rotate smoothly within the corresponding semicircular grooves, thereby allowing the first frames and the second frames to fold into a collapsed configuration. Conversely, when the folding cover is to be deployed for use, an operator applies an outward pulling force to the two first frames, such that each first frame is pivoted to a position perpendicular to the adjacent second frame. In the unfolded configuration, the folding cover forms a stable structure suitable for installation. By virtue of the cooperative interaction among the two first frames, the two second frames, the two semicircular grooves, and the two semicircular plates, the folding cover can collapse into a compact configuration. The collapsibility reduces the spatial volume of the folding cover during storage or transport, thereby minimizing the complexity and cost associated with handling, packaging, and logistics.

In use, the latch block, the latch interface, and the rotary shaft are cooperatively structured to form a stable and detachable connection between the first frames and the second frames. The stop plate is configured to abut against one side of the adjacent second frame to inhibit displacement or misalignment of the second frame during the folding or unfolding operations. The structural arrangement enhances the mechanical stability of the folding cover and facilitates smooth actuation between the folded and unfolded states. The directional indicator is configured to provide visual guidance for the folding and unfolding, thereby assisting the operator to quickly identify the correct direction of movement of the frame assembly.

The lightweight groove reduces the weight of the frame assembly, thereby facilitating the handling and transportation of the folding cover. The positioning hole facilitates precise alignment and positioning between the first frame and the adjacent second frame.

### BRIEF DESCRIPTION OF THE DRAWINGS

FIG. 1 is a perspective view of a folding cover according to one example of the disclosure;

FIG. 2 is a top view of the folding cover in FIG. 1;

FIG. 3 is a bottom view of the folding cover in FIG. 1;

FIG. 4 is an enlarged view of part a in FIG. 3;

FIG. 5 is a first perspective view of an engagement between a first frame and a second frame according to one example of the disclosure;

FIG. 6 is a second perspective view of an engagement between a first frame and a second frame according to one example of the disclosure; and

FIG. 7 is a perspective view of a folding cover in a folded state according to one example of the disclosure.

In the drawings, the following reference numbers are used: 101. First frame; 102. Second frame; 3. Semicircular groove; 4. Semicircular plate; 5. Latch block; 6. Latch interface; 7. Rotary shaft; 8. Stop block; 9. Stop plate; 10. Directional indicator; 11. Lightweight groove; and 12. Positioning hole.

### DETAILED DESCRIPTION

To further illustrate the disclosure, embodiments detailing a folding cover for an air filter unit are described below. It should be noted that the following embodiments are intended to describe and not to limit the disclosure.

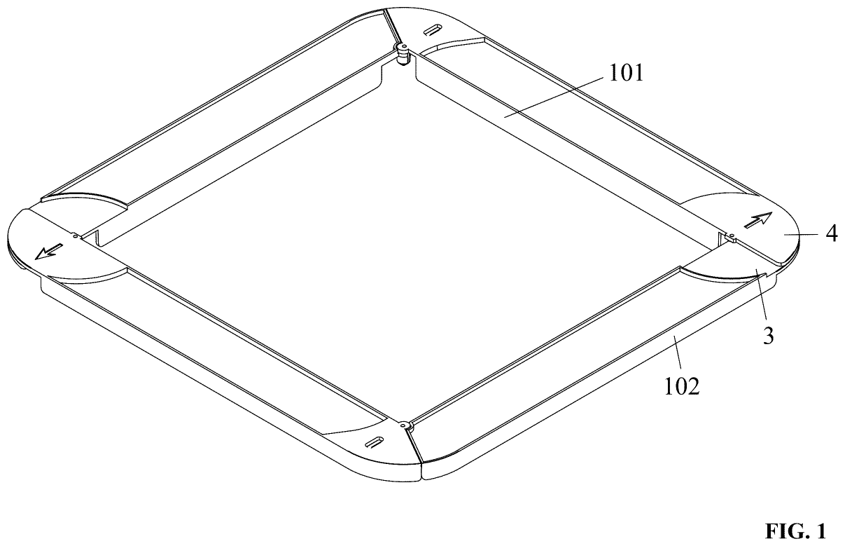

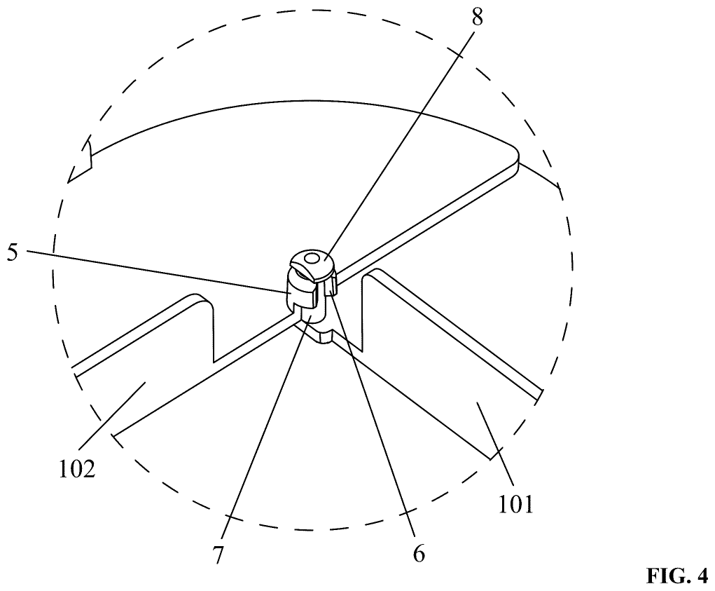

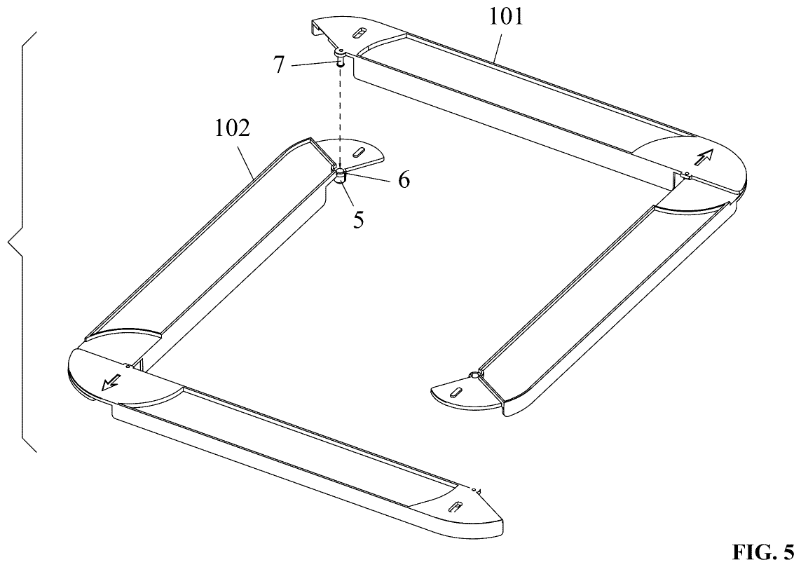

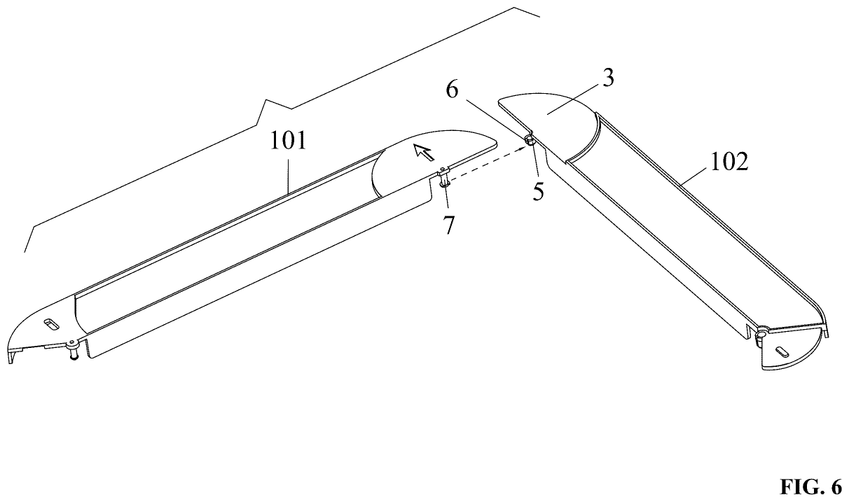

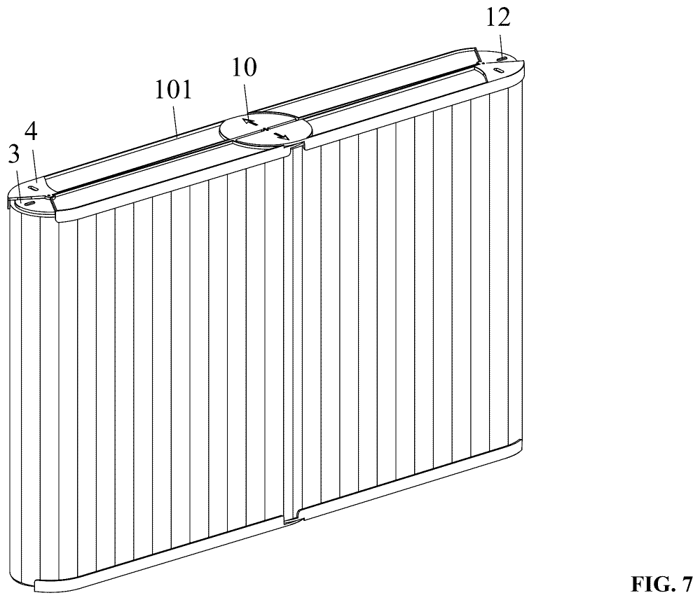

As shown in FIGS. 1-7, a folding cover comprises two frame assemblies. The two frame assemblies are symmetrical about a central point; each of the two frame assemblies comprises two first frames 101 and two second frames 102; the two first frames 101 are disposed opposite to each other, and the two second frames 102 are disposed opposite to each other. The two first frames 101 are connected to the two second frames 102, respectively. Each of the two first frames 101 comprises a first end, a second end, a first top surface, and a first bottom surface. A semicircular plate 4 is fixedly disposed on the first end of each first frame 101. Each of the two second frames 102 comprises a third end, a fourth end, a second top surface, and a second bottom surface. The second top surface of each second frame 102 comprises a semicircular groove 3. The semicircular groove 3 is disposed on the third end of the second frame 102. The semicircular plate 4 is rotatably disposed within the semicircular groove 3. The second end of the first frame 101 is pivotally connected to the fourth end of the second frame 102.

When the folding cover is to be stored or transported, the two second frames 102 are urged inward toward one another, thereby causing the two semicircular plates 4 to rotate smoothly within the corresponding semicircular grooves 3, thereby allowing the first frames 101 and the second frames 102 to fold into a collapsed configuration.

Conversely, when the folding cover is to be deployed for use, an operator applies an outward pulling force to the two first frames 101, such that each first frame 101 is pivoted to a position perpendicular to the adjacent second frame 102. In the unfolded configuration, the folding cover forms a stable structure suitable for installation. During installation onto a filter body (not shown) of an air filter unit, two folding covers are disposed respectively on an upper surface and a lower surface of the filter body. The air filter unit referenced herein is of known construction and may be implemented in accordance with the disclosure of U.S. Patent No. 10,888,809B2, the entirely of which is hereby incorporated by reference. The folding cover disclosed herein is dimensioned and configured for compatibility with the filter body of the air filter unit disclosed in the reference.

By virtue of the cooperative interaction among the two first frames 101, the two second frames 102, the two semicircular grooves 3, and the two semicircular plates 4, the folding cover is collapsed into a compact configuration. The collapsibility reduces the spatial volume of the folding cover during storage or transport, thereby minimizing the complexity and cost associated with handling, packaging, and logistics.

As shown in FIGS. 1-7, the second bottom surface of each second frame 102 comprises two latch blocks 5. Each latch block 5 comprises a side wall defining a latch interface 6. Each semicircular plate 4 comprises a third top surface and a third bottom surface. Both the third bottom surface of each semicircular plate 4 and the first bottom surface of each of the two first frames 101 comprise a rotary shaft 7; the rotary shaft 7 is detachably disposed in the latch block 5 through the latch interface 6; and one end of the rotary shaft 7 is fixed with a stop block 8.

In use, the latch block 5, the latch interface 6, and the rotary shaft 7 are cooperatively structured to form a stable and detachable connection between the first frames 101 and the second frames 102. The rotary shaft 7 is securely latched into the latch block 5 through the latch interface 6, and the stop block 8 prevents disengagement of the rotary shaft 7 during the rotational movement. The configuration enhances mechanical reliability while enabling efficient assembly and disassembly of the folding cover.

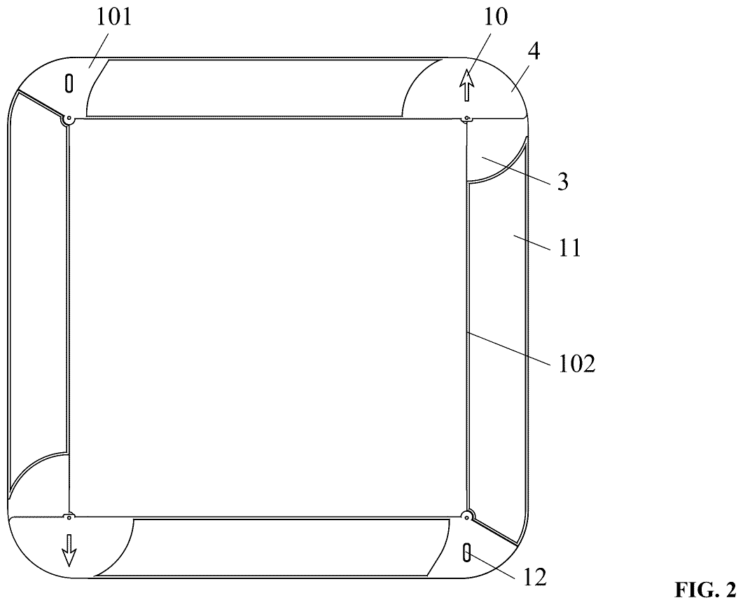

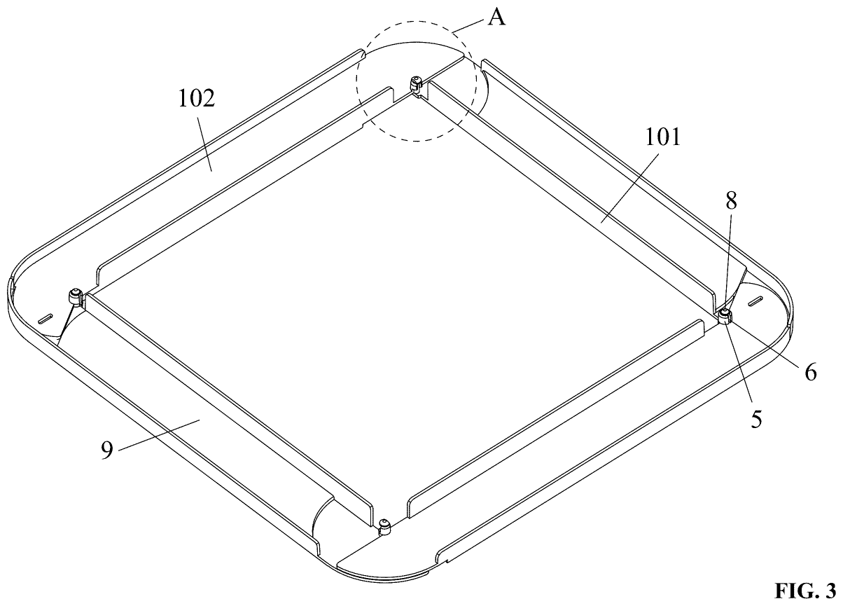

As shown in FIG. 3, the first bottom surface of each first frame 101 comprises a stop plate 9. As shown in FIG. 2, the third top surface of each semicircular plate 4 comprises a directional indicator 10.

In use, the stop plate 9 is configured to abut against one side of the adjacent second frame 102 to inhibit displacement or misalignment of the second frame 102 during the folding or unfolding operations. The structural arrangement enhances the mechanical stability of the folding cover and facilitates smooth actuation between the folded and unfolded states. The directional indicator 10 is configured to provide visual guidance for the folding and unfolding directions, thereby assisting the operator to quickly identify the correct direction of movement of the frame assembly.

As shown in FIG. 2, both the first top surface of each of the two first frames 101 and the second top surface of each of the two second frames 102 comprise a lightweight groove 11 and a positioning hole 12.

The lightweight groove 11 reduces the weight of the frame assembly, thereby facilitating the handling and transportation of the folding cover. The positioning hole 12 facilitates precise alignment and positioning between the first frame 101 and the adjacent second frame 102. When the positioning hole 12 formed in the first frame 101 is aligned with the positioning hole 12 on the adjacent second frame 102, the first frame 101 and the second frame 102 are positioned in a perpendicular orientation, thereby confirming that the frame assembly has been properly assembled.

It will be obvious to those skilled in the art that changes and modifications may be made, and therefore, the aim in the appended claims is to cover all such changes and modifications.

What is claimed is:

1. A folding cover, comprising two frame assemblies, wherein,
the two frame assemblies are symmetrical about a central point;
each of the two frame assemblies comprises two first frames and two second frames;
the two first frames are disposed opposite to each other, and the two second frames are disposed opposite to each other;
the two first frames are connected to the two second frames, respectively;
each of the two first frames comprises a first end, a second end, a first top surface, and a first bottom surface; a semicircular plate is fixedly disposed on the first end of each first frame;
each of the two second frames comprises a third end, a fourth end, a second top surface, and a second bottom surface; the second top surface of each second frame comprises a semicircular groove; the semicircular groove is disposed on the third end of the second frame; the semicircular plate is rotatably disposed within the semicircular groove; and the second end of the first frame is pivotally connected to the fourth end of the second frame.

2. The folding cover of claim 1, wherein the second bottom surface of each second frame comprises two latch blocks; each latch block comprises a side wall defining a latch interface; each semicircular plate comprises a third top surface and a third bottom surface; both the third bottom surface of each semicircular plate and the first bottom surface of each of the two first frames comprise a rotary shaft; the rotary shaft is detachably disposed in the latch block through the latch interface; and one end of the rotary shaft is fixed with a stop block.

3. The folding cover of claim 2, wherein the first bottom surface of each first frame comprises a stop plate.

4. The folding cover of claim 3, wherein the third top surface of each semicircular plate comprises a directional indicator.

5. The folding cover of claim 1, wherein both the first top surface of each of the two first frames and the second top surface of each of the two second frames comprise a lightweight groove.

6. The folding cover of claim 5, wherein both the first top surface of each of the two first frames and the second top surface of each of the two second frames comprise a positioning hole.
